(19) United States
(12) Patent Application Publication
(10) Pub. No.: US 2004/0162844 A1
(43) Pub. Date: Aug. 19, 2004

(54) Driver management system and method

(75) Inventors: Randy Thome, Oshkosh, WI (US); Mike Kuphal, Greenville, WI (US); Tom Harter, Neenah, WI (US); Randy Lifke, Neenah, WI (US); Tim Miller, Appleton, WI (US); Dean Stelow, Oneida, WI (US); Steve Nelson, Neenah, WI (US); Paul Naundorf, Neenah, WI (US); Christa Williams, Van Dyne, WI (US); Chad Govin, Appleton, WI (US); Sven Bugge, Neenah, WI (US); Jim Moen, Appleton, WI (US); Cheryl Van Grinsven, Appleton, WI (US); Joe Harrington, Appleton, WI (US); Rick Haslip, Hortonville, WI (US)

Correspondence Address: MICHAEL BEST & FRIEDRICH, LLP, 100 E WISCONSIN AVENUE, MILWAUKEE, WI, 53202, US

(73) Assignee: J. J. Keller & Associates, Inc., Neenah, WI

(21) Appl. No.: 10/427,205

(22) Filed: Apr. 30, 2003

Related U.S. Application Data
(60) Provisional application No. 60/447,126, filed on Feb. 13, 2003.

(51) Int. Cl. G06F 17/00

(52) U.S. Cl. 707/102

(57) ABSTRACT

An integrated, multiple-function management system and method that allows trucking companies and carriers to enhance the efficiency of their operation. The method includes receiving data for at least one individual, comparing the individual's data with operational requirements, and notifying a destination entity if the individual's data does not comply with the operational requirements. The method further includes subscribing to diverse entities for information relating to the individual, receiving information from a subscribed entity, determining if the received information corresponds with the individual's information, associating the received information with the corresponding individual and determining if the received information relates to an operational requirement.

### REFERENCE TO RELATED APPLICATION

This application claims the benefit of U.S. Provisional Application No. 60/447,126, filed on Feb. 13, 2003, which is incorporated herein by reference in its entirety.

### BACKGROUND

The invention relates generally to the field of employee management. More specifically, embodiments of the invention relate to systems and methods for computerized management of employees operating under government regulations such as commercial truck drivers.

In many countries and particularly the United States of America, it is well known that over-the-road trucks ship a large proportion of all goods sold or distributed in the marketplace. In the United States, shipment by truck ranks as the number one method of transporting goods and it is expected that the trucking industry will continue to grow in the coming decades.

As the trucking industry has grown, a variety of laws and regulations have been promulgated to regulate trucking activities. Under the U.S. Department of Transportation, the FMCSA (Federal Motor Carrier Safety Administration) has established a comprehensive list of regulations that a professional driver must comply with. These regulations govern the driver, the trucking company (sometimes called a “carrier”) and the truck. Professional drivers must comply with the obligations imposed under federal and state requirements in these areas. The regulations not only include physical and age requirements, but also define the ways a driver can lose his commercial driving privileges. Trucking companies and companies having trucking operations that support their core business are typically required to evaluate and track many aspects of truck drivers and their abilities to perform job tasks such as driver qualifications (such as operator licensing and renewal); alcohol and drug testing; accident reporting; driver training; and hiring and screening of applicants.

A commercial carrier asks for proof that a driver prior to operating their truck has met the applicable state and federal regulations. Many carriers require that a driver complete the requirements themselves and are qualified to operate their vehicles in interstate commerce. Most employment applications address these qualifications. Depending on the type of information being gathered carriers must acquire specific pieces of information. Some information is requested from the driver, previous employers, and third parties (states, companies that gather motor vehicle reports, background checks, etc.). Most relevant information requested from the driver is also verified from these other sources. Information on the application is used to begin the process of gathering information from these sources.

For example, a driver at age eighteen can drive a commercial truck within the boundaries of a state (intrastate). However, to operate a commercial motor vehicle across state lines (interstate), an operator must be at least 21 years old. Meeting the age requirement does not legally entitled one to become a commercial truck driver. Being able to read and speak the English language well enough to take instructions from highway signs, and to converse with officials and complete the required reports is a requirement. As the vehicles have become easier to handle, and shippers and receivers do more loading and unloading, the physical requirements of a truck driver have become less severe. The Federal Government does require that a truck driver can “safely operate the type vehicle he/she drives” and is familiar with the methods needed to secure the cargo appropriately. The driver must also be able to determine whether the cargo is adequately loaded and secured before leaving the shipper. Physical impairments must be considered and cannot interfere with operating a motor vehicle. This includes a dependence on insulin for diabetics, any known predisposition to serious heart failure, any respiratory dysfunction, or muscular or vascular disease that might impair operations. The driver should not be subject to any mental disorders, which might impair operations and must be able to pass the vision and hearing requirements, and not be diagnosed with alcoholism or illegal drug use.

If a driver is involved in an accident, he may be asked to submit to a substance abuse test. Recent legislation allows local law enforcement personnel to conduct this testing if the carrier cannot. If the test results are positive for drugs or alcohol, a driver may have certain rights to be re-tested. However, until the second test is confirmed, a driver will be suspended from driving duties.

The final requirements define the ways a driver can be disqualified from operating a commercial vehicle. These include driving a commercial motor vehicle while under the influence of alcohol, driving under the influence of illegal drugs, or transporting or possessing illegal drugs. Additionally, a conviction of leaving the scene of an accident while operating a commercial vehicle or committing a felony involving a commercial vehicle is a disqualification.

The carrier is required to keep copies of all of the above in a file, along with the certificate of completion for a road test. The carrier is required to have his drivers complete an annual review of their driving record, any updates, and a list of any violations in a driver's personnel file.

### SUMMARY

Although, there are various paper-based systems and software that assist trucking companies with some of the areas noted above, such systems are not completely satisfactory. The continued growth and regulation of the trucking industry as well as the increasingly sophisticated logistical mechanisms used to ensure timely and efficient delivery of goods makes it imperative for trucking companies to accurately and efficiently manage their truck drivers. Therefore, it is useful for a trucking company to have available a tool for collecting and displaying information relating to the tasks which must be performed under the regulations in order for the company to show that it and its drivers are in compliance.

The inventors have discovered that it would be desirable to have an integrated, multiple-function management system and method that allows trucking companies and carriers to enhance the efficiency of their operation.

One aspect of the present invention provides methods for managing commercial drivers. Methods according to this aspect of the invention include receiving data for at least one individual, comparing the individual's data with operational requirements, and notifying a destination entity if the individual's data does not comply with the operational requirements. The method further includes subscribing to diverse entities for information relating to the individual, receiving information from a subscribed entity, determining if the received information corresponds with the individual's information, associating the received information with the corresponding individual and determining if the received information relates to an operational requirement.

Systems according to the invention include a data store for receiving information for at least one individual, the information includes information relating to operational requirements, a compliance engine coupled to the data store comparing the individual's information with operational requirements, and a notification engine coupled to the compliance engine operative to select a destination entity based on the compliance engine comparison. The system further includes a plurality of channels enabling two-way communication between a like plurality of predetermined entities, a normalizer coupled to the plurality of channels to accept and convert received information into a compatible format, a subscription engine coupled to the compliance engine and the normalizer, the subscription engine subscribes to external systems for individual information and regulatory requirements and a notification gateway to send notification to the destination entity.

Other objects and advantages of the systems and methods will become apparent to those skilled in the art after reading the detailed description of the preferred embodiment.

### BRIEF DESCRIPTION OF THE DRAWINGS

FIG. 1 is a block diagram of an exemplary computer.

FIG. 2 is a block diagram of an exemplary computer network.

FIG. 3 is a detailed block diagram of the data center shown in FIG. 2.

FIG. 4 is an exemplary application architecture.

FIG. 5 is an exemplary framework of the individual modules of the invention.

FIG. 6 illustrates an exemplary structure of the various displays of the invention.

FIG. 7 is a browser window showing an exemplary user interface of the invention.

FIG. 8 is a browser window showing an exemplary home page display.

FIG. 9 is a browser window showing an exemplary applicant display.

FIG. 10 is a browser window showing an exemplary third party report request display.

FIG. 11 is a browser window showing an exemplary employee file display.

FIG. 12 is a browser window showing an exemplary driver qualification file display.

FIG. 13 is a browser window showing an exemplary alcohol and drug file display.

FIG. 14 is a browser window showing an exemplary alcohol test results entry display.

FIG. 15 is a browser window showing an exemplary pre-employment alcohol and drug test display.

FIGS. 16a and 16b are browser windows showing an exemplary random employee selection display.

FIG. 17 is a browser window showing an exemplary accident file display.

FIG. 18 is a browser window showing an exemplary training file display.

FIG. 19 is a browser window showing an exemplary reports and forms display.

FIG. 20 illustrates an exemplary hiring process method.

FIG. 21 illustrates an exemplary alert method.

### DETAILED DESCRIPTION OF THE PREFERRED EMBODIMENTS

Embodiments of the invention will be described with reference to the accompanying drawing figures wherein like numbers represent like elements throughout. The invention is taught using professional driver compliance as the business application. However, the invention is not limited by this example and can be applied to other applications that require policing employee regulatory requirements such as employment in the nuclear power industry, medical profession, etc. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

In one embodiment, the invention provides an online service that assists in the control of a wide variety of driver/employee management and compliance functions. These functions include driver qualification and ongoing driver management; driver hiring, applicant tracking, applicant screening; management of background checking, MVR (Motor Vehicle Records), and drug and alcohol testing programs; management of corporate and location level training programs; management of accident information; management of confidential employee information; the ability to access documents as electronic images; real-time notification of federal, state, local, and company specific compliance issues, activities, or requirements regarding drivers and equipment; corporate level reporting and compliance summaries based on organization structure; and secured access to information based on job function, location, or area of responsibility.

Embodiments of the invention provide a driver management computer-readable media server application allowing a commercial carrier to implement a consistent safety and compliance program capable of responding to all applicable regulations and standardize a wide variety of driver management functions. The functionality of the application provides a carrier with an individual and customizable interactive home page that displays the following: the status of driver recruiting, driver application processing and hiring; the ability to order and receive MVR reports for drivers; available driver qualifications; alcohol and drug testing information from external agencies; accident and incident record keeping; training program creation and maintenance; employee file management; and compliance and management reporting. Files maintained for each driver include driver qualification, training, accident, alcohol and drug testing and a general employee file. Reports and applicable forms are provided as well. The invention provides notification when any items of interest require attention or more importantly, where the lack of attention will result in a non-compliance issue with the regulating authorities.

As described above, a plurality of regulatory requirements are imposed on commercial drivers. All of the federal and applicable state regulations are contained within the application and are used to perform the necessary compliance tasks. The regulatory requirements are kept current by periodic updates from the regulatory authorities or by queries made from the system to their locations and will update those regulations that have undergone revision.

In one embodiment, the invention is deployed as a Web-enabled framework and is accessed through a GUI (Graphical User Interface). The application code resides on a server. Users access the framework by accessing the GUI via a Web-enabled browser such as Microsoft IE (Internet Explorer) or others over the Internet using Internet standards and scripting languages including HTML (Hypertext Markup Language), DHTML (Dynamic HTML), Microsoft VBScript (Visual Basic Scripting Edition), Jscript, ActiveX and Java. A user contacts the Web server hosting the application and requests information or resources. The Web server locates, and then sends the information to the Web browser, which displays the results.

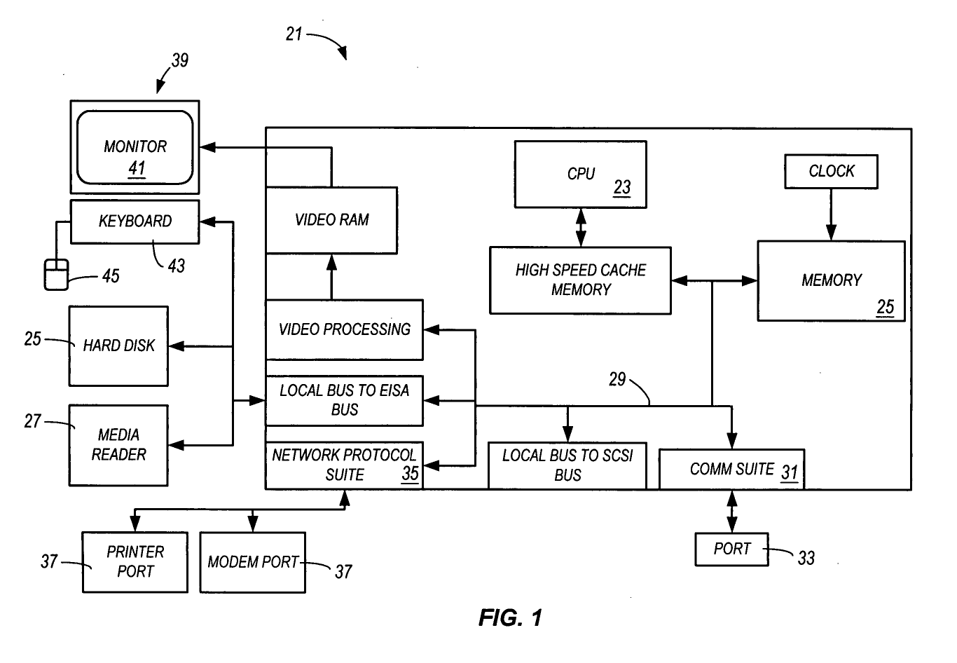

An embodiment of a computer 21 executing the instructions of one embodiment of the invention is shown in FIG. 1. A representative hardware environment is depicted which illustrates a typical hardware configuration of a computer. Each computer 21 includes a CPU 23, memory 25, a reader 27 for reading computer executable instructions on computer readable media, a common communication bus 29, a communication suite 31 with external ports 33, a network protocol suite 35 with external ports 37 and a GUI 39. The communication bus 29 allows bi-directional communication between the components of the computer 21. The communication suite 31 and external ports 33 allow bi-directional communication between the computer 21, other computers 21, and external compatible devices such as laptop computers and the like using communication protocols such as IEEE 1394 (FireWire or i.LINK), IEEE 802.3 (Ethernet), RS (Recommended Standard) 232, 422, 423, USB (Universal Serial Bus) and others. The network protocol suite 35 and external ports 37 allow for the physical network connection and collection of protocols when communicating over a network. Protocols such as TCP/IP (Transmission Control Protocol/Internet Protocol) suite, IPX/SPX (Internetwork Packet eXchange/Sequential Packet eXchange), SNA (Systems Network Architecture), and others. The TCP/IP suite includes IP (Internet Protocol), TCP (Transmission Control Protocol), ARP (Address Resolution Protocol), and HTTP (Hypertext Transfer Protocol). Each protocol within a network protocol suite has a specific function to support communication between computers on a network. The GUI 39 includes a graphics display such as a CRT, fixed-pixel display or others 41, a key pad, keyboard or touchscreen 43 and pointing device 45 such as a mouse, trackball, optical pen or others to provide an easy-to-use, user interface for the invention. The computer 21 can be a handheld device such as an Internet appliance, PDA (Personal Digital Assistant), Blackberry device or conventional personal computer such as a PC, Macintosh, or UNIX based workstation running their appropriate OS (Operating System) capable of communicating with a computer over guided or unguided media. The CPU 23 executes compatible instructions or software stored in the memory 25. Those skilled in the art will appreciate that the invention may also be practiced on platforms and operating systems other than those mentioned.

The invention is executed preferably on a server in an Internet environment or using a network. Networks allow more than one user to work together and share resources with one another. Aside from distributed processing, a network provides centralized storage capability, security and access to resources.

Network architectures vary for LANs (Local Area Networks), WANs (Wide Area Networks), and networks that use terminals to connect to mainframes. Some examples of LAN network architectures include Ethernet, token ring, FDDI (Fiber Distributed Data Interface) and ATM (Asynchronous Transfer Mode). The capability of individual computers being linked together as a network is familiar to one skilled in this art.

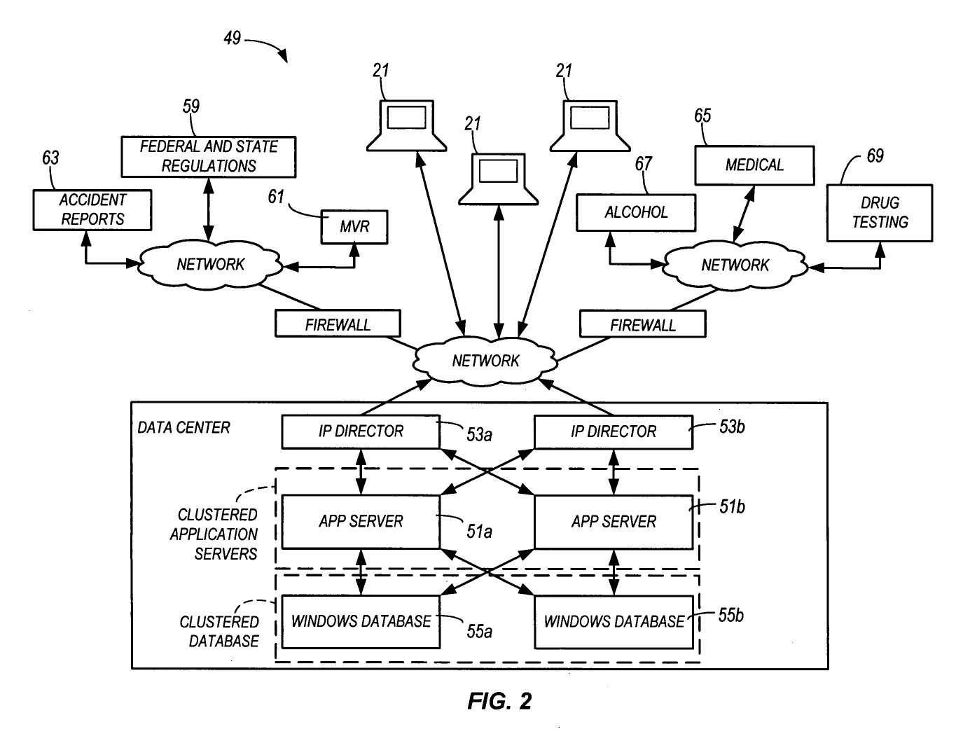

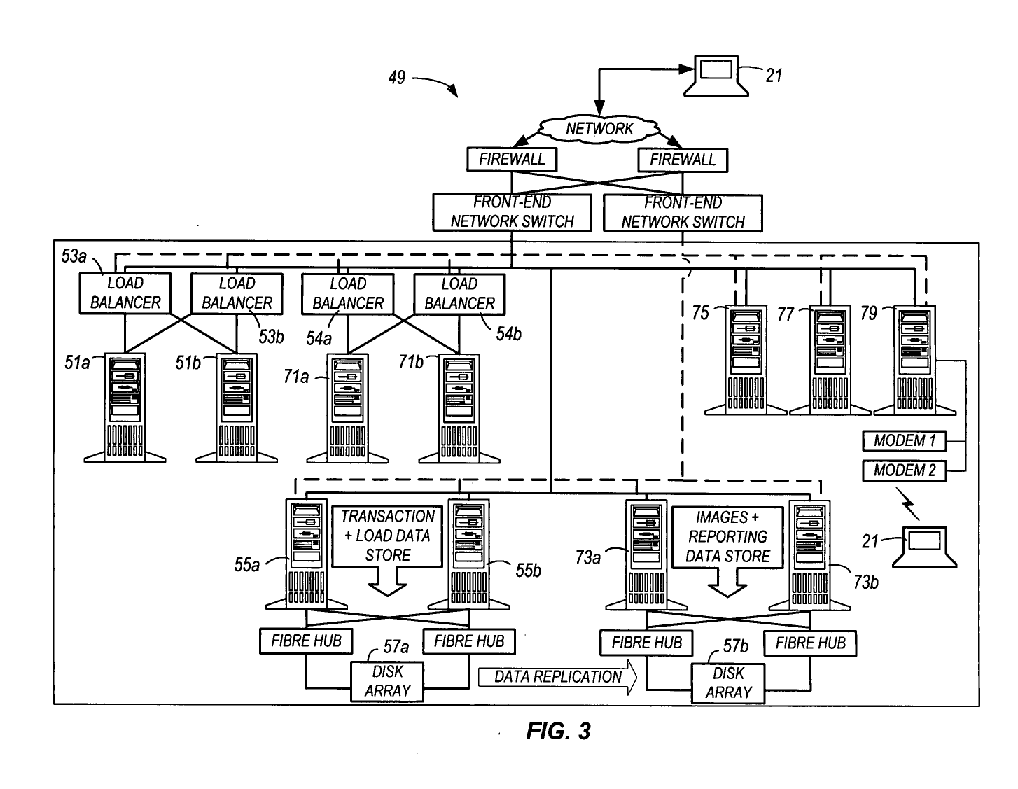

An example network 49 executing the invention framework is shown in FIGS. 2 and 3. In one embodiment, the invention resides in a data center on two application servers 51a, 51b. The servers 51a, 51b are computers 21 running ISS (Internet Information Server) configured with Microsoft .NET Framework that hosts the invention. The .NET Framework is an environment for building, deploying, and running Web services and applications, and is part of Microsoft's .NET Platform. IIS configured with the .NET Framework is a Windows compliant application server that can run on computers 21 running Windows Server operating systems. The invention can be deployed on any .NET compliant application server. As one skilled in this art will recognize, other platforms and frameworks can be used along with application servers such as WebLogic, WebTrends, WebSphere, Oracle Application Server, Jboss, etc. Clustering is a redundancy mechanism used to share data between two different application servers so each participant of the cluster can act as a standby in case one of the participants of the cluster crashes. Clustering achieves high availability and transparent switchover. The servers 51a, 51b are also load balanced using a hardware solution such as an IP director 53a, 53b for distributing the computing load among them. In one embodiment, the IP directors, Cisco or Alteon switches are arranged in a master-standby configuration to ensure that the framework is not susceptible to a single point failure. This ensures that the framework is available to the network in case one of the switches (IP director) fails. The servers 51a, 51b communicate with a clustered Windows database running on separate servers 55a, 55b using clustered RAID (Redundant Array of Independent Disks) 10 storage 57a, 57b. Clustering provides similar redundancy to avoid data unavailability in case one of the servers fails. Other database technologies such as Oracle can be used.

The network 49 is used to provide a communication path between the framework, users, and external service providers. The service providers range from information sites such as those hosting current regulatory requirements 59, MVR 61 and driving records 63 to others providing specific services or information about an applicant or current employee such as medical records 65, and alcohol 67 and drug tests 69.

Also included are primary and redundant reporting 73a, 73b servers similarly load balanced using IP director 54a, 54b and image servers 71a, 71b. Administration services for the application are provided for by notification 75, DNS (Domain Name System) 77 and BDC (Backup Domain Controller) 79 servers which provide internal network functions.

The infrastructure is a repository for storing and accessing the database tables stored at the RDBMS (Relational Database Management System) SQL (Structured Query Language) server 55a, 55b. The RDBMS is a client/server for the Microsoft Windows 2000 and Windows Server operating systems. An SQL server is a client/server database system. The server runs the SQL server database software, which processes requests submitted by the database client software and sends the results back to the client. All users that use the application can be monitored. All aspects of use can be logged such as who a particular user is, the period of use, the version of the browser, and what events have taken place such as edits, deletes, updates, additions to the system and other activities.

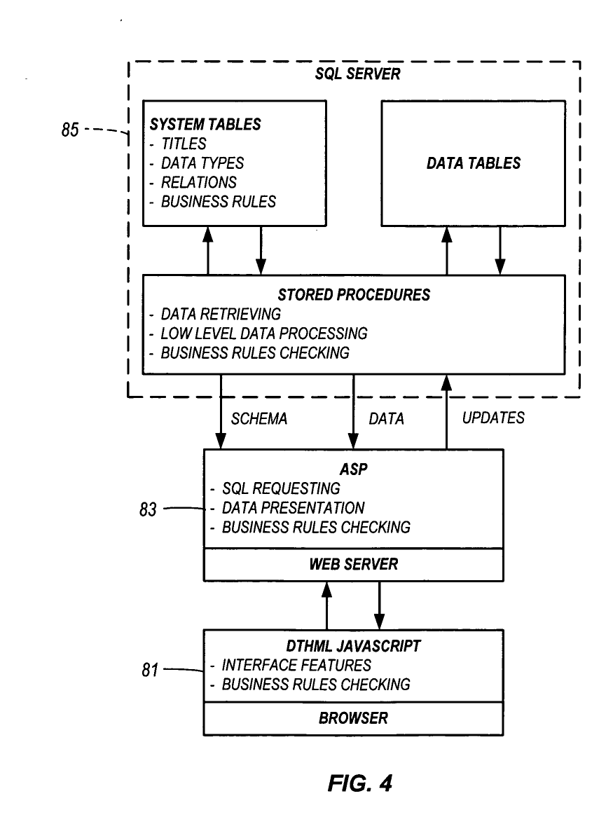

Since the application is built using Web-based technology and is available everywhere, employees or others having authorized access can access the network data through an Internet browser 81 such as IE, or others, as shown in the application architecture corresponding to the infrastructure shown in FIG. 4. Individual computers 21 at a plurality of locations can communicate with a plurality of Web servers 83, which in turn communicate with the SQL server 85 hosting the application. A communication path is established between the browser 81 executed on a computer 21 and the SQL server 85 through an ASP (Active Server Pages) application environment using IIS Web servers 83. ASP.NET is the .NET version of ASP+and provides programming models for building Web forms and distributed Web-based applications. The SQL server 85 executes the application and serves as the repository for all database information.

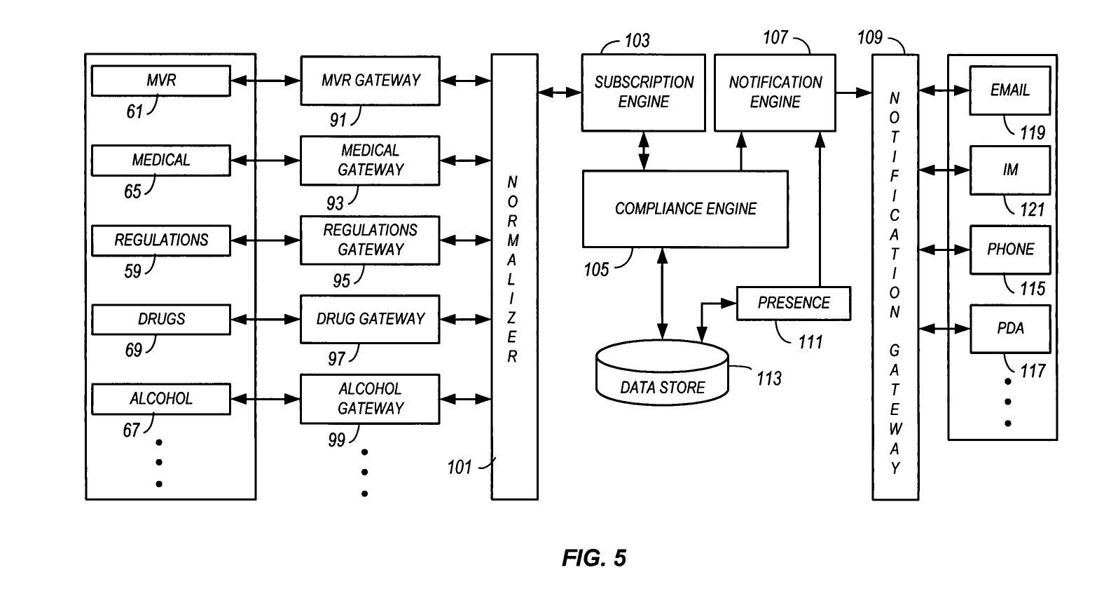

Preferably, the invention framework is secure and allows effective integration of database information, external Web Services and agency compliance regulations through a set of software modules. Shown in FIG. 5 is the Driver management framework of the various modules that comprise the invention as executed in the data center. The modules include external system gateways 91, 93, 95, 97, 99 and others, a normalizer 101, a subscription engine 103, a compliance engine 105, a notification engine 107, a notification gateway 109, a presence module 111 and a data store 113.

The external system gateways 91, 93, 95, 97, 99 are software modules that accept information from external systems, third parties and Web Services, and converts them using the normalizer 101 into a compatible format for the framework. The gateways 91, 93, 95, 97, 99 support XML (eXtensible Markup Language). A gateway is used for the Driver management framework to access each external system. Each gateway subscribes for information from its associated external system, such as sites for MVR 61, a site or a plurality of sites pertaining to a carrier's fleet of vehicles (information regarding vehicle recalls), current fuel prices, vehicle maintenance and repair, and others. Upon receiving and normalizing information, each gateway forwards the information to the compliance engine 105 for processing.

The subscription engine 103 allows each external system to be subscribed to, thereby exposing information. The invention framework knows each of the external systems a priori by URL (Uniform Resource Locator) or by search engine if unreachable or not known. The subscription engine subscribes for information for a particular employee or periodically for regulatory or employee update information. The information that is exposed by the subscription engine 103 is listed as objects. The subscription request is a .NET object. The subscription engine 103 submits the object to the compliance engine 105 for further processing.

The compliance engine 105 executes the application logic. The compliance engine 105 operates in conjunction with the subscription and notification engines 103 and 107 and facilitates joining responses returned from these engines.

The notification engine 107 routes information to multiple devices 111, 113, 115, 117 and others, with two-way communication capability. It contains abstract notification rules that can select one or multiple relevant targets and notify them via various channels.

The presence module 111 gathers the presence of users on different channels like IM or Blackberry devices and writes it to the data store 113. The presence module 111 gathers presence information from users using IM clients. When an IM user logs on using IM client software, the client software sends presence information such as, on-line, off-line, away, busy, off-to-lunch, etc. to an IM server. The presence module 111 registers its interest with the IM server to observe all presence traffic. When the IM server receives presence information, it is delivered to the presence module 111 that stores each user presence data in the data store 113. The presence module 111 can also gather the user phone presence information, for example, on-hook, off-hook, dialing, call-in-progress, etc. The presence module 111 receives the information from a PBX exchange and stores the phone presence data in data store 113. The presence module 111 can also receive data from a GPS (Global Positioning System) receiver to determine the physical presence location of a user. Presence data assists the invention framework to determine which delivery mode to choose for notification purposes.

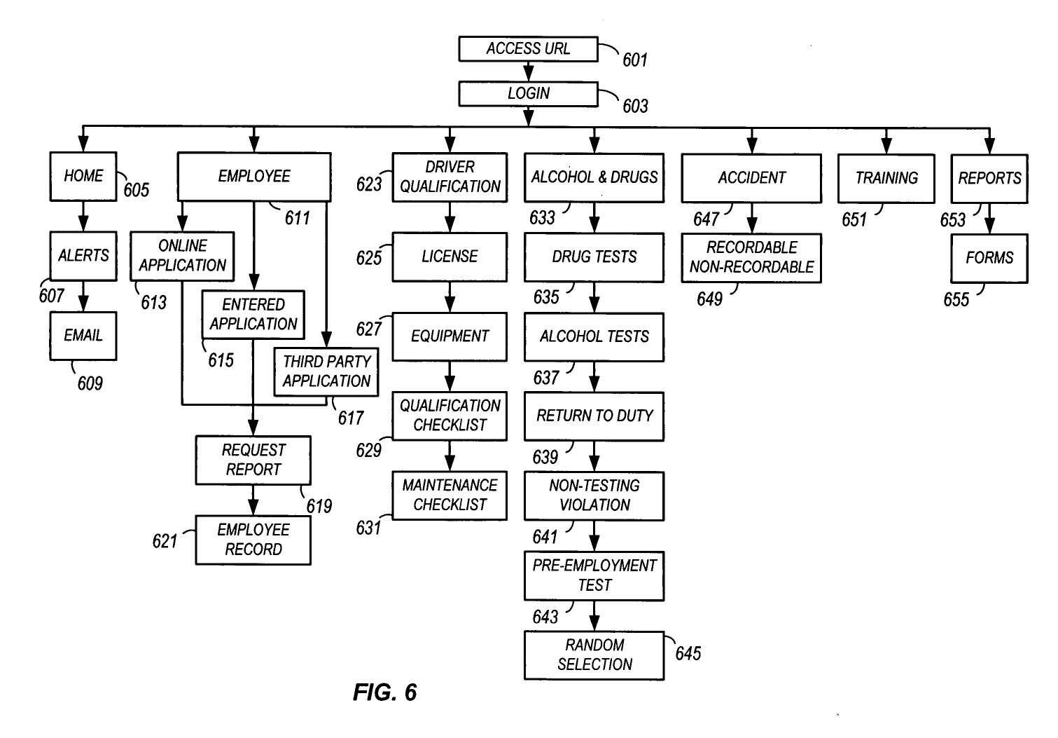

FIG. 6 is a diagram showing the structure of one embodiment of the invention. Since the application is built using Web-based technology and is an HTML based Web-enabled utility, an Internet browser such as IE, or others, using a network can access the application. Individual computers 21 at a plurality of locations can communicate with the Web server layer 83 of the application server hosting the application. The data store 113 stores operational instructions for the application, database fields, regulatory requirements, preferred modes of contact for company administrators, and other storage needs. The data store 113 can be distributed over the server 51a, 51b, computer 21, memory 25, or data center mass storage 57a, 57b. The database can be accessed and overwritten to provide the functionality and assemble the user interface displays of the invention.

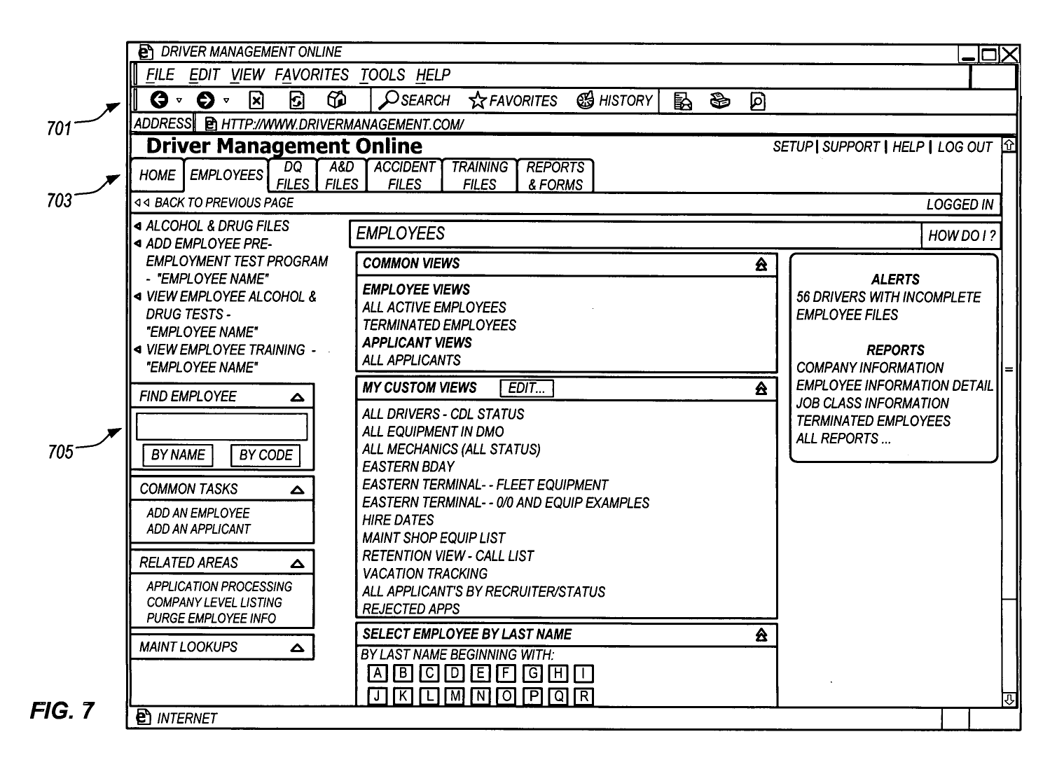

Using the pointing device 45, a user accesses the application by opening a browser on a computer 21 and addresses the Web browser to a specific URL as shown in FIG. 7 (step 601). Typical users are agents or employees of a shipping or trucking company that access the application to perform a variety of tasks. The user then logs on with a user identification and password (step 603). Using conventional GUI interface devices such as a title bar, toolbars, pull-down menus, tabs, scroll bars, context help, dialog boxes, operating icons, buttons, status bar and others 701, the user navigates throughout the displays, bringing other displays in focus. The tabs 703 gain access to the different areas of driver management content such as home (user's home page), employee, driver qualification, alcohol and drugs, accident, training, and reports and forms. The display appears in the browser window with a toolbar that includes an employee search (name) utility 705. The user can change applicant or employee queries at any time under any tab.

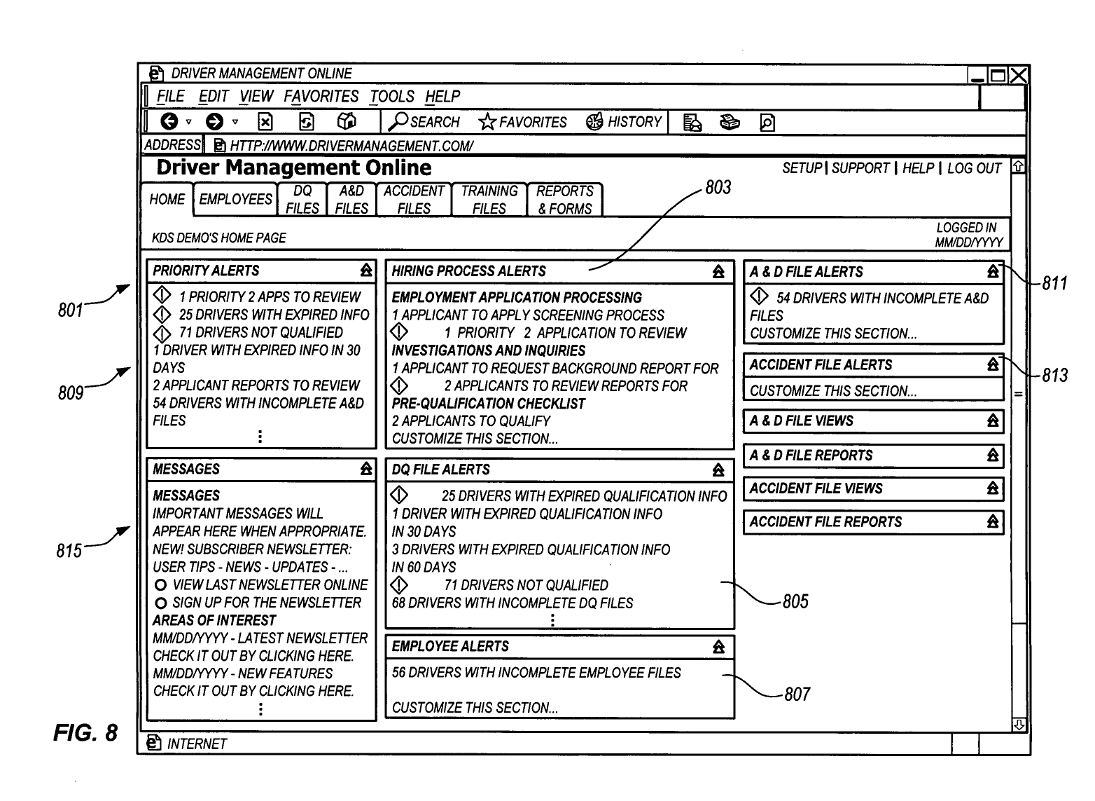

The home tab (step 605) is designed to conveniently and automatically display alerts 801 (step 607) and annunciate items that require attention, additional information, or completion as shown in FIG. 8. The home tab displays alerts for all areas of employee regulatory compliance. Alerts are provided for hiring process 803, driver qualification 805, employee 807, training 809, alcohol and drug 811, and accident information 813. The alerts are presented in a general format whereby the user can select a particular alert and proceed to a more detailed summary. Priority alerts bring attention to non-compliance issues that can impact the day-to-day operations of the carrier. For example, if an alert was posted for three drivers with expired qualifications 809, the user can mouse over the alert (using the pointing device 45) and select, bringing into focus a new display listing the names and information pertaining to the expirations. On this display, the user can descend deeper into the information fields presented as well. The alerts can also be provided via email, IM, Blackberry or others channels of communication in accordance with how a user directs notification. The presence module 111 affords this capability. Under each tab, an online help function is provided.

Additional information is presented on the home page as messages 815 (step 609). For example, information updates generated by the application. If a regulation has been revised or amended by the regulating body, the change is automatically incorporated into the data store 113 by the application over a gateway, and posted as a message on the user's home page announcing that a change has occurred.

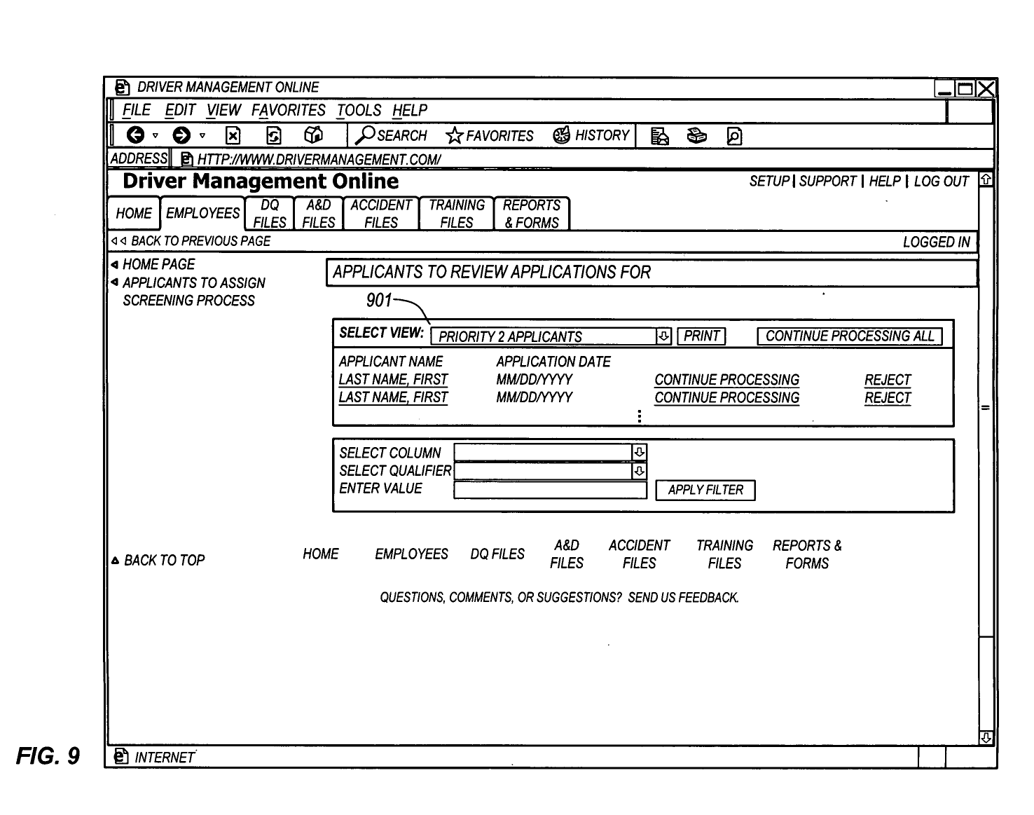

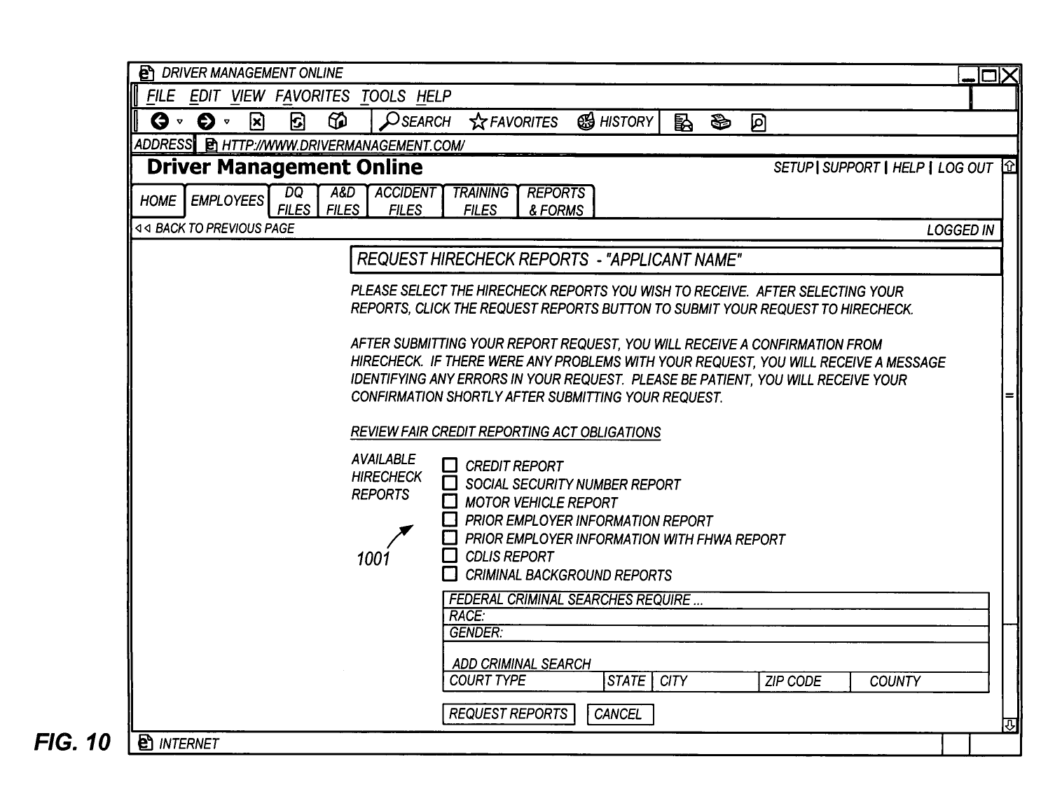

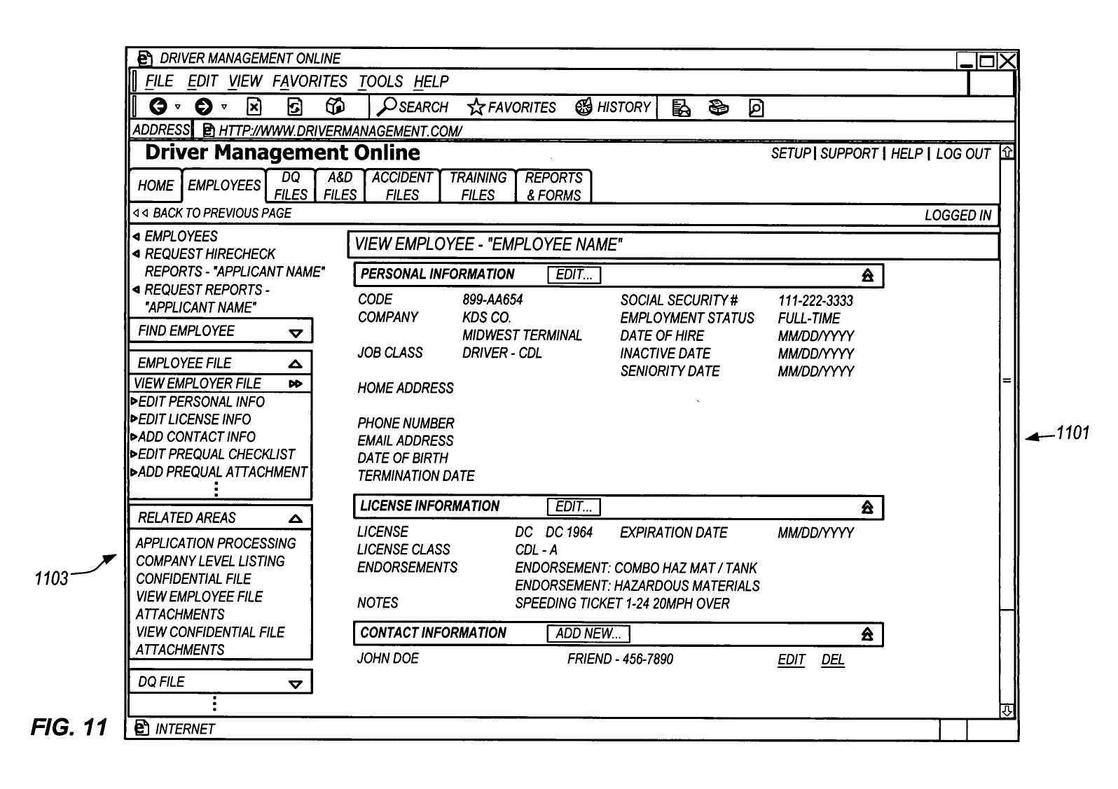

Under the employee tab as shown in FIG. 9, the user can view driver applications 901 (step 611) from an available online form (step 613), applications submitted by third parties (step 615), or applications submitted by postal mail and input to the application via a computer 21 (step 617). This display provides information on driver recruiting, application processing and hiring. The user has the ability to review each application (applicant) submitted and either reject, or continue the application screening process. From the driver application, additional background information 1001 can be ordered for an applicant as shown in FIG. 10 such as a credit report, a social security number report, MVR, a prior employer information report, previous employer information on-file with the FHWA (Federal Highway Administration), a CDLIS (Commercial Driver License Information System) report, a criminal background report, and others (step 619).

The application subscribes to each requested authority or service for the desired reports via the subscription engine 103 and external gateways. When the information is received from the external services, the information is normalized (in the normalizer 101) and processed in the compliance engine 105. The alerts on the home page are real-time. The email communication can be configured for delivery once a day, at a predetermined timed interval, or immediately. The user is made aware of the newly received information by his choice, either by logging in to the application home page, by email, or other modes of delivery as indicated by the presence module 111 and notification gateway 109. For example, if a user wished to be notified as soon as possible when a criminal background report for a particular applicant was received, he can specify notification by email, pager, Blackberry device or other mode of delivery. The user can always review each of the requested reports on his home page when they become available.

The employee tab provides access to information pertaining to all employee information as shown in FIG. 11. Information such as first name, last name, street address, city, county, state, country, phone listings, email, social security number, date of birth, license numbers, years of experience, types of vehicles driven, and other applicable information 1101 (step 621). Additional information pertaining to an applicant can also be considered. Information such as a resume, certifications, citations or other documents that can be digitized are received and entered in a compatible, electronic document format such as IP (Internet Protocol) Fax, PDF (Portable Document Format), and others, and associated with an applicant or employee as an attachment 1103. All external systems providing information in response to a subscription request can submit information in this manner as well. The application maintains the documents in the data store 113.

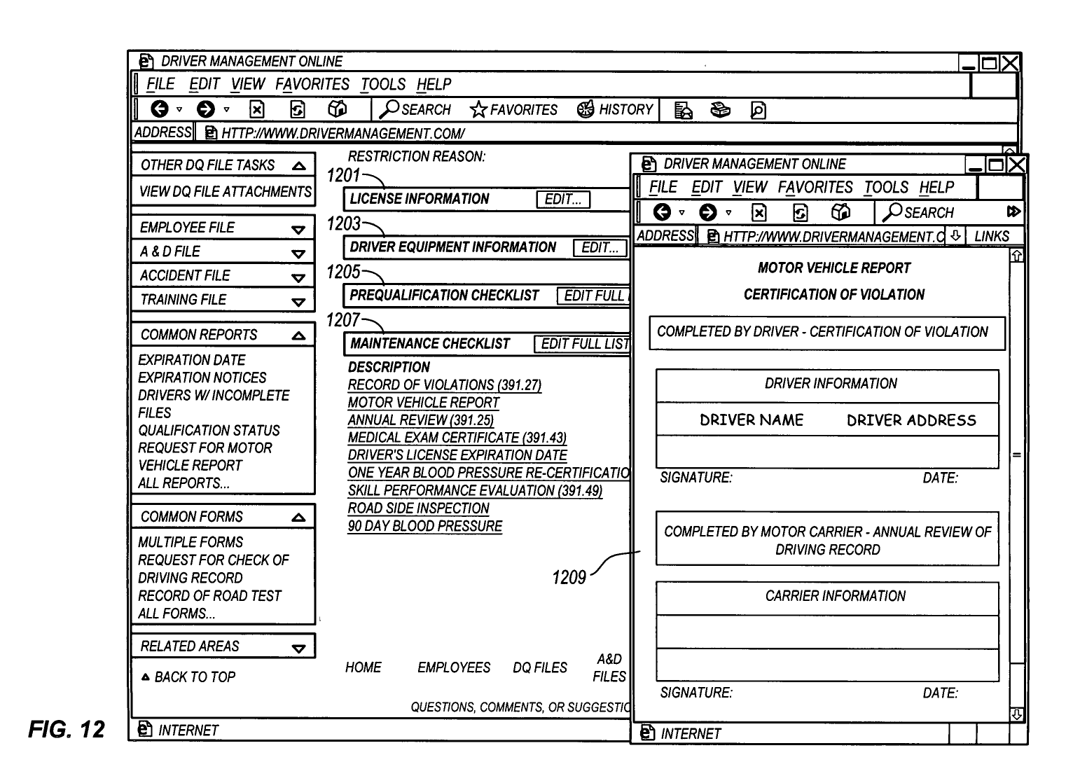

Under the driver qualification tab, information pertaining to a specific driver can be viewed as shown in FIG. 12 (step 623). Information such as license information (current/expiration date) 1201 (step 625), equipment qualification 1203 (step 627), pre-qualification checklist 1205 (step 629), maintenance checklist 1207 (step 631) and others are viewable. Under equipment qualification 1203, information on whether an employee was first qualified, if currently qualified, if on probation or has any associated restrictions can be viewed. Additional documents 1209 can be digitized and input to the application for association with an applicant or current employee with any aspect under qualification.

Under license information 1201 (step 625), information such as state, expiration date, class of operation, license number, endorsements and notes can be viewed. Under driver equipment 1203 (step 627), a driver's authority, dispatch range and types of equipment authorized to operate can be viewed. Pre-qualification checklist 1205 is used to obtain, complete and record DOT (Department of Transportation) and company-specific information when an employee is first hired. Pre-qualification checklist (step 629) items include a motor vehicle report for the current state, medical examination certificate, waiver letter (a DOT form that allows a person who is not physically qualified to drive a commercial vehicle), all having associated due dates.

Information listed under the maintenance checklist 1207 (step 631) is for general DOT and company-specific information due dates. Each entry has more depth, viewable by mousing over the entry and selecting, bringing into focus a display having more detailed information. The date entries are tracked by the application to provide alerts. For example, a yearly blood pressure screening requirement is monitored by the application and will provide an alert a predetermined period of time prior to the expiration date. The same applies to all other entries so marked, for example, driver license renewals, driver skill evaluations, required medical examinations, and others.

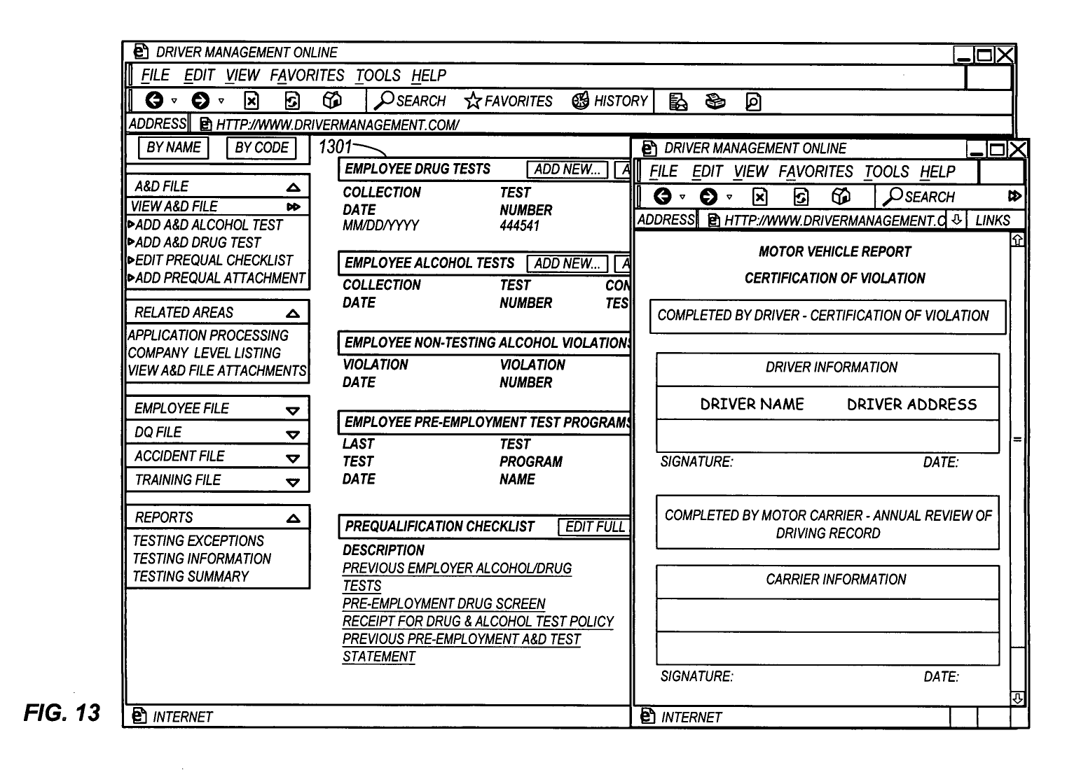

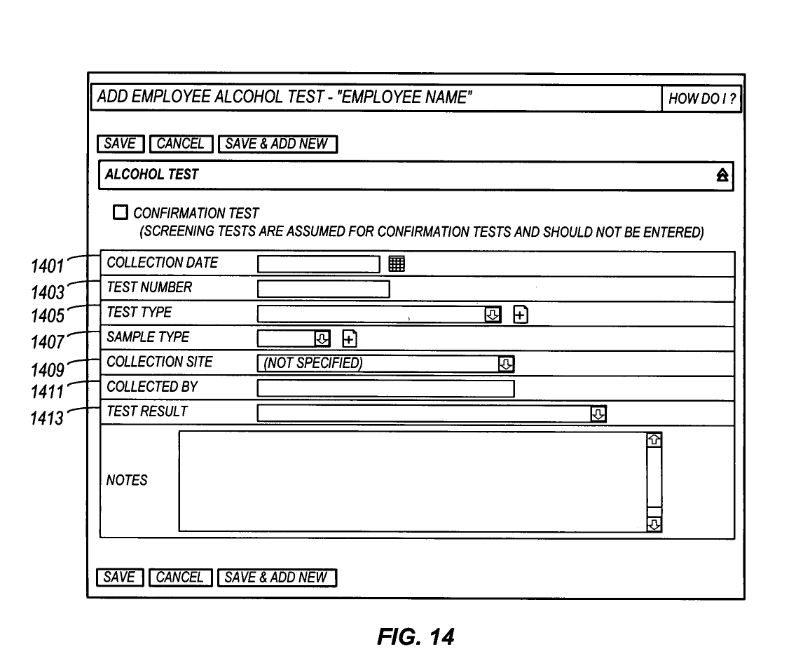

Under the alcohol and drugs tab, all drug and alcohol related information pertaining to an employee is presented and organized as shown in FIG. 13 (step 633). From pre-employment drug screening to regulatory requirements, all compliance requirements are displayed along with any drug and alcohol violations. Information listed under drug and alcohol tests is general and has an associated date. Each entry has more depth, viewable by mousing over and selecting, bringing into focus a display having more detailed information. For example, as shown in FIG. 14, drug test related information includes: collection date 1401, test number 1403, test type 1405 (drop-down list), sample type 1407 (drop-down list), collection site 1409 (drop-down list), collected by information 1411 (name), lab 1413 (drop-down list), analyzed by (name), MRO (Medical Review Officer from drop-down list), test result (drop-down list), disposition (drop-down list), substances (from check-box), notes, and other fields (step 635). Alcohol test information includes: confirmation date (from check-box), collection date, test number (from EBT-Evidential Breath Testing device, or other), test type (drop-down list), sample type (drop-down list), collection site (drop-down list), collected by (name), lab (drop-down list), analyzed by (name), MRO (Medical Review Officer from drop-down list), test result (drop-down list), disposition (drop-down list), notes, and other fields (step 637). Each entry is tracked by the application to provide alerts. For example, a yearly drug test requirement is monitored by the application and will provide an alert a predetermined period of time prior to the expiration date. Or if a random testing schedule is called for, the application can generate a random schedule for all employees and provide an alert at the predetermined time for compliance and fitness for duty (step 639).

The application tracks follow-up test information if a non-complying disposition is noted. Additionally, violations for not participating in a drug test are noted that include, the violation date, violation number (predetermined), non-testing alcohol violation, disposition of employee, notes, and other fields (step 641).

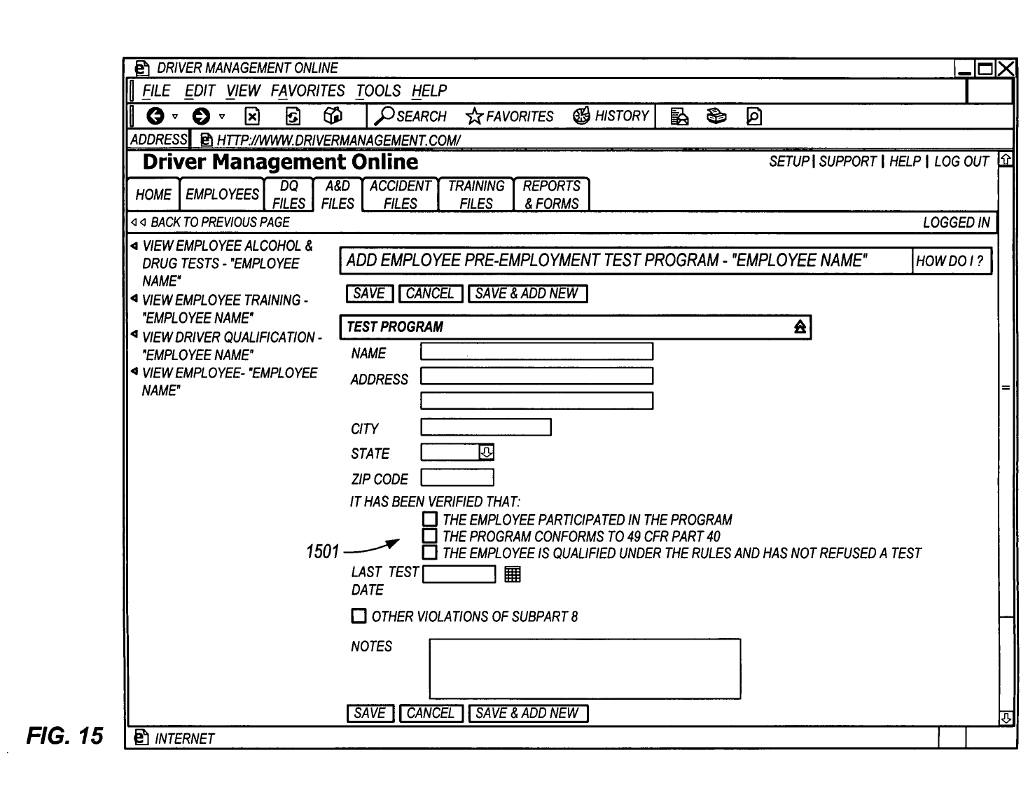

A pre-employment test program is included in the application to assist a carrier to obtain, complete, and record DOT and company-specific information when an employee is first hired (step 643) as shown in FIG. 15. The checklist 1501 indicates where the applicant is in his compliance schedule. Under DOT (Department of Transportation) regulations, an employer is not required to administer a controlled substance pre-employment test if the applicant has participated in a drug testing program that meets the requirements within the previous 30 days, and while participating in that program, the applicant either was tested for controlled substances within the past 6 months (from the date of application with your company) or participated in a random controlled substances testing program for the previous 12 months (from the date of application with your company) and the employer ensures that no prior employer of the driver of whom the employer has knowledge has records of a violation of this part of the controlled substance use rule of another DOT agency within the previous six months.

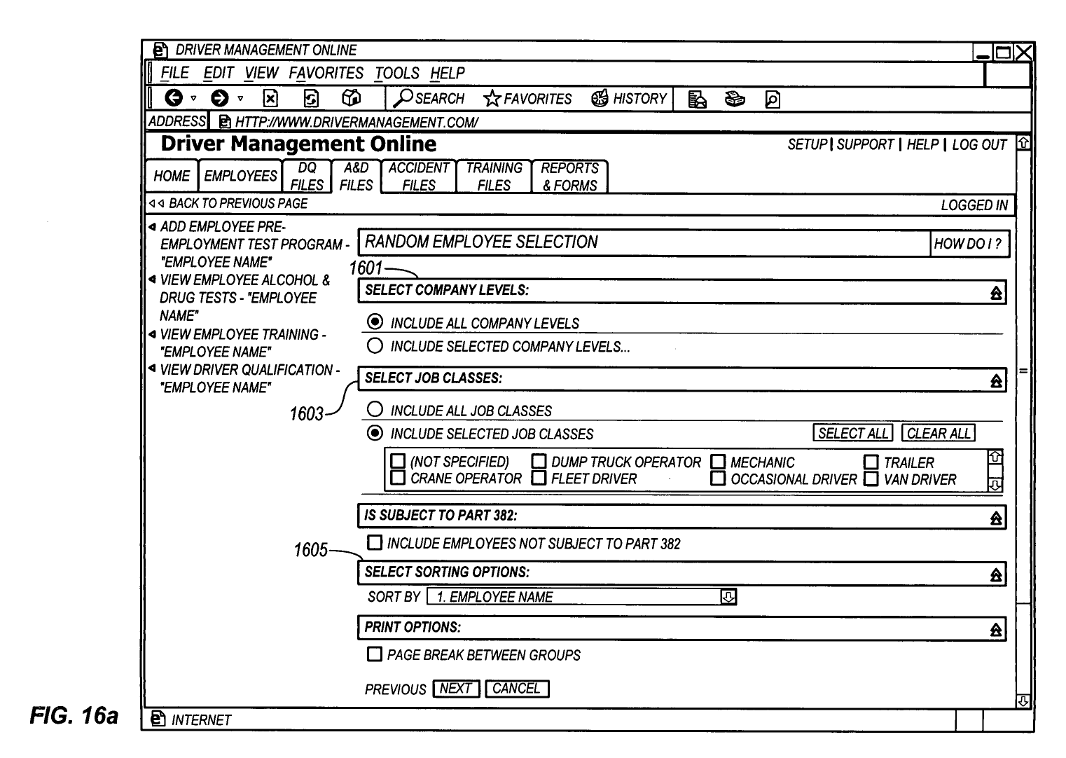

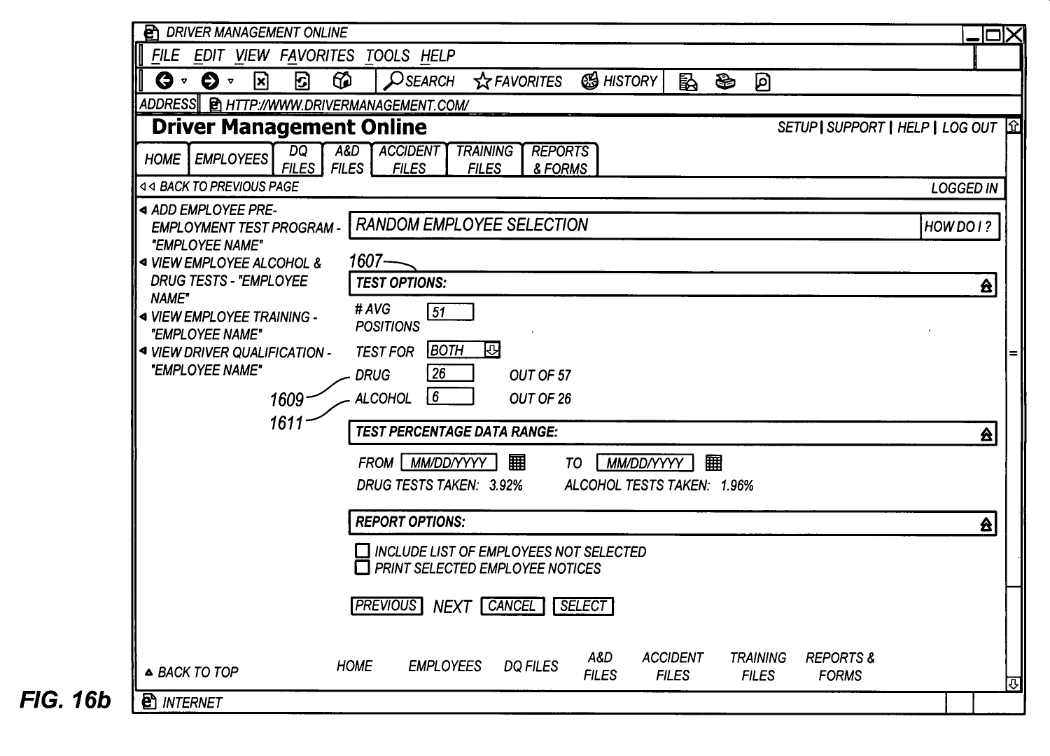

The application has a random number generator to select employees for random alcohol and drug testing (step 645) as shown in FIGS. 16a and 16b. The random number ensures that each employee that meets the selection criteria has an equal chance of participating in a test each time the random selection is performed. Selection criteria is met in the system by marking the employee (or the job class the employee is assigned to) subject to random selection. In addition, when running a random selection, there is a parameter screen that the user can use to specify subsets of employees. The random function allows the carrier to select the levels 1601 and job class 1603 of employees for testing, and how the employee list can be sorted 1605. The user selects either drug or alcohol testing. For drug testing 1607, the value arrived at by the application is:

$$randomdrug = \frac{AVG \times ( 0.5 )}{freq .} \qquad ( 1 )$$

where randomdrug 1609 is the arrived at value, AVG is the number of employees and freq. is the frequency, either weekly (52), monthly (12) or, quarterly (4).

For alcohol testing, the value arrived at by the application is:

$$randomalcohol = \frac{AVG \times ( 0.1 )}{freq .} \qquad ( 2 )$$

where randomalcohol 1611 is the arrived at value, A VG is the number of employees and freq. is the frequency, either weekly (52), monthly (12) or quarterly (4). A test percentage date range is entered to calculate the percentage of tests already taken. The DOT requires a certain percentage of drivers to be tested annually for alcohol and/or drug usage. The random alcohol and drug selections randomly select applicable employees to be tested. The DOT mandates that the selection is random in nature. Equations (1) and (2) show how the invention arrives at the number of drivers to randomly pick when a random selection is being performed. For example, if there are 100 employees and an alcohol test is given once every year, AVG equals 100 and freq. equals one, resulting in randomalcohol equal to 10. Ten drivers require random testing. The random pool of employees is the 100 employees. The random number generation determines which employees should be selected to be one of the ten out of 100. A random number is generated, for example 87. The 87^{th} person is selected. Another random number is generated, for example, the number 2. The second person in the pool is selected, and so on.

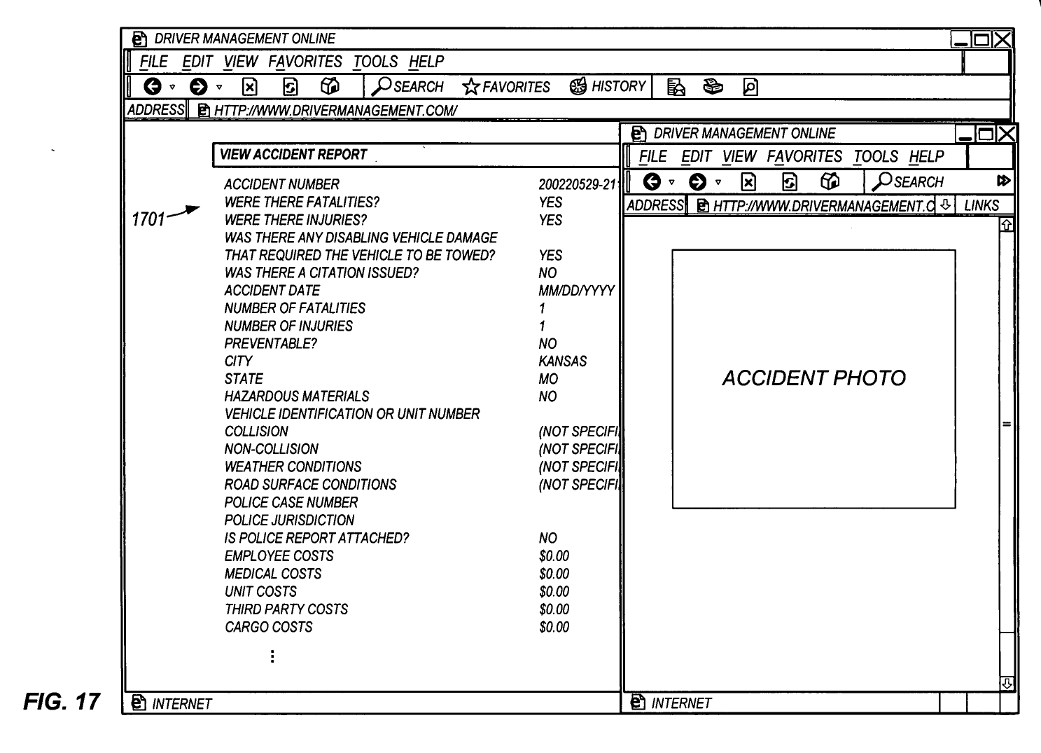

Under the accident tab, detailed information pertaining to each accident a driver experiences can be entered and displayed as shown in FIG. 17 (step 647). A preliminary checklist is presented to determine whether an accident should be recorded. The checklist begins with whether there were any fatalities, any injuries, any disabling vehicle damage that required the vehicle to be towed, and was a citation issued to the driver. If any of the queries are answered affirmatively, the accident should be recorded 1701. If none of the questions are applicable, the accident information can still be entered, however, indicated as non-recordable (step 649). Recordable accident information is recorded in a Motor Vehicle Accident Register resident in the data store 113. The register is a regulatory requirement. A number is generated comprising a date and a random number that is assigned by the application and associated with a recordable accident entry. Accidents can be searched for a particular driver, vehicle, fleet of vehicles or operating region.

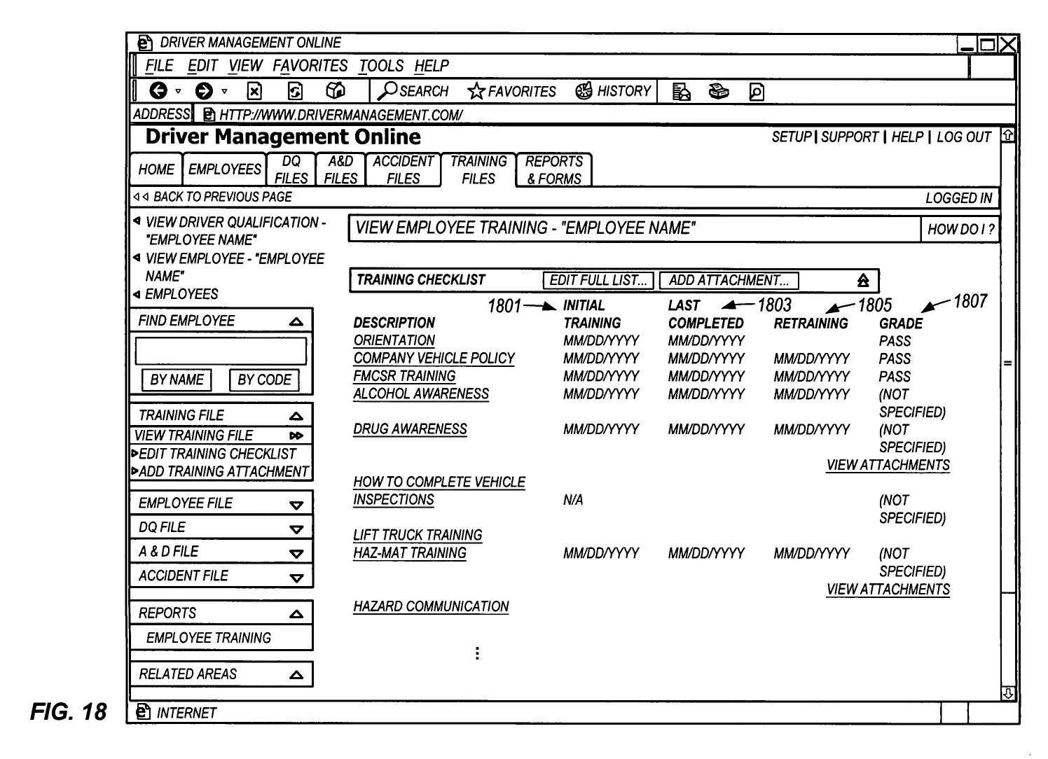

Under the training tab, all employee-training programs are listed as shown in FIG. 18 (step 651). Each line item has dates for initial training 1801, last completed 1803, retraining 1805 and grade 1807. Programs can be indicated as not applicable for certain employees. For example, those drivers who will not be transporting nuclear waste or flammable substances can be excluded from certain training programs. Training programs completed can be indicated as pass/fail or other grading system, and date completed.

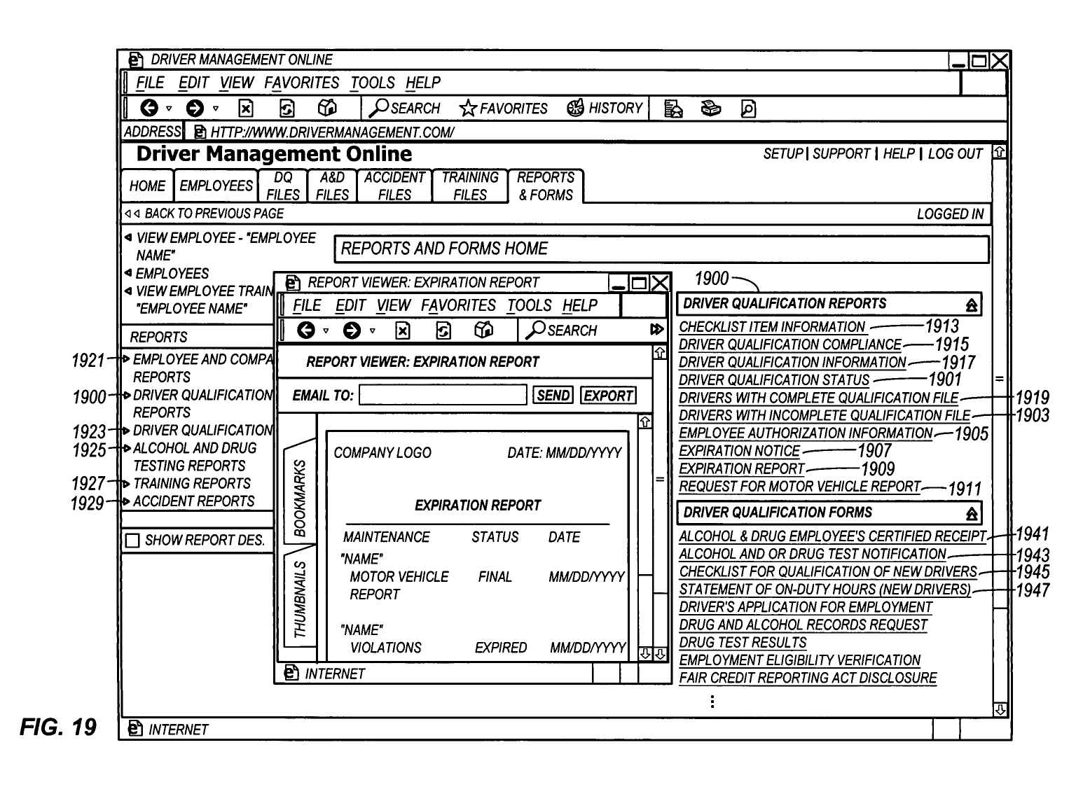

Under the reports and forms tab, a plurality of formatted reports can be generated as shown in FIG. 19 (step 653). The formatted reports for driver qualification 1900 include driver qualification status 1901, drivers having an incomplete qualification file 1903; employee authorization information 1905; expiration notice 1907; expiration report 1909; request for motor vehicle report 1911; checklist item information 1913; driver qualification compliance by company level 1915; driver qualification information 1917; drivers with complete qualification file 1919, employee authorization information, and others. Reports for employee 1921, qualification forms 1923, alcohol and drug testing 1925, training 1927 and accident 1929 are also available. Custom reports can be assembled.

Each report can be printed locally, or archived, or saved locally. The report can also be forwarded to an interested party via email as an RTF (Rich Text Format) or PDF (Portable Document Format) file if desired.

Forms are available in a form library in the data store 113 (step 655). For example, forms under driver qualification include alcohol and drug employee's certified receipt 1941, alcohol and/or drug test notification 1943, checklist for qualification of new drivers 1945, driver statement of on-duty hours 1947, and others are provided. Custom forms can be assembled as well using simple word-processing tools, or Adobe Acrobat forms having assignable/common fields. Each tab subject has a list of respective forms.

An automated billing system initiated by the administration server 79 tallies the total use of the application per user (client) and forwards an electronic bill to them on a prearranged basis for use of the system.

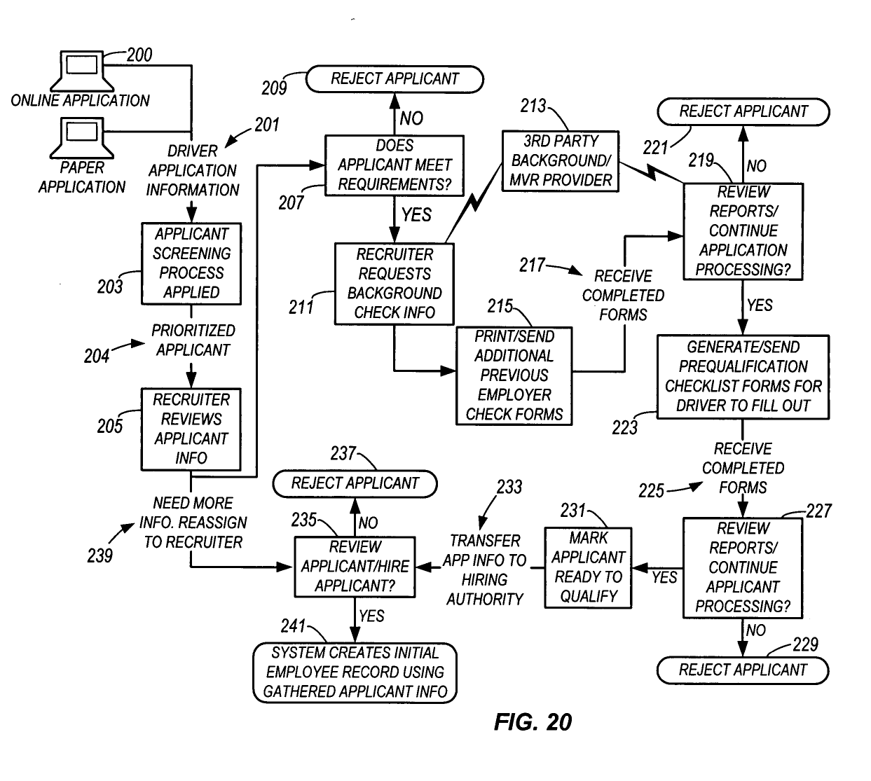

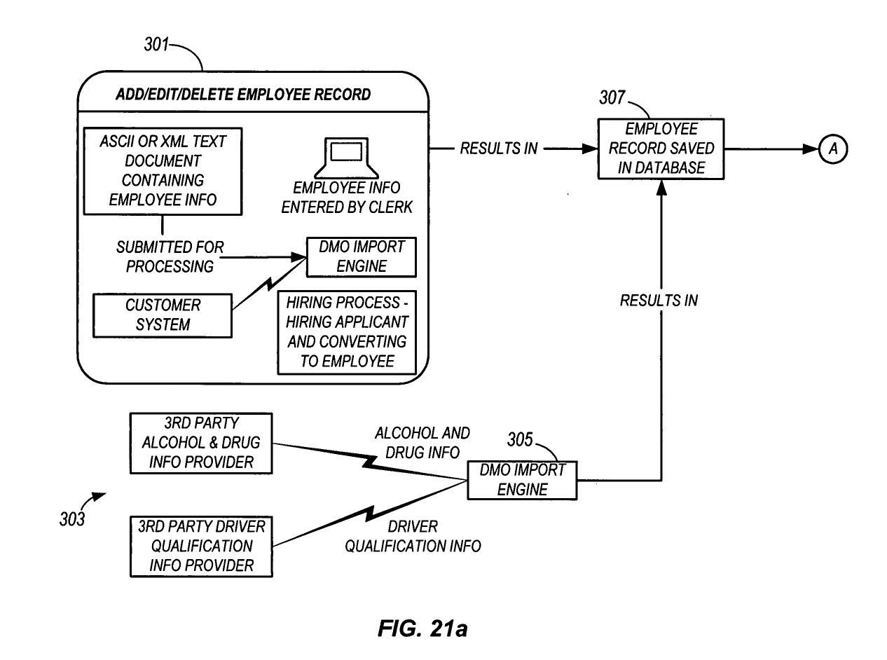

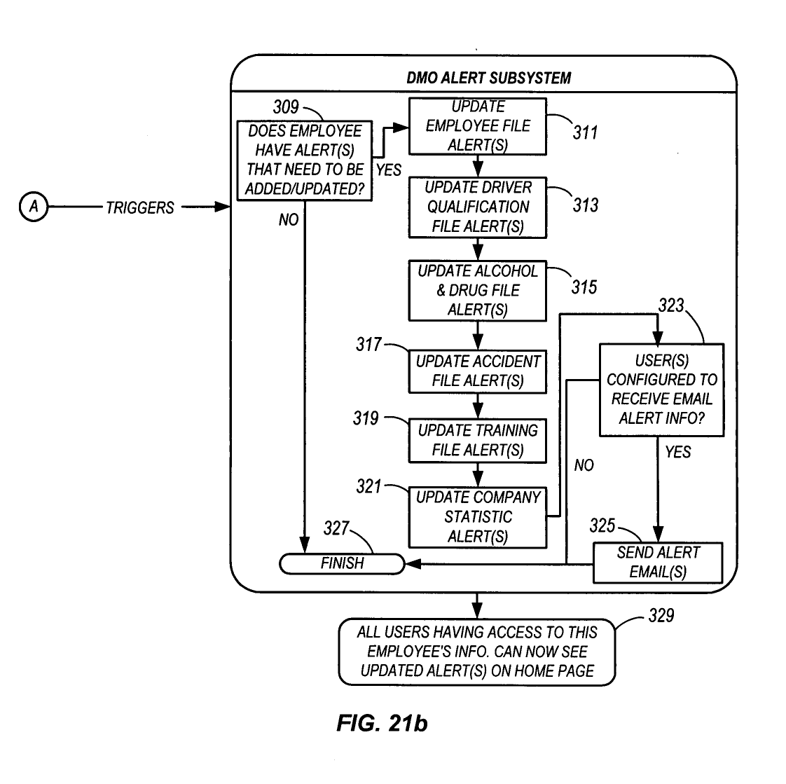

One embodiment of the invention processes data as shown in FIGS. 20 and 21. FIG. 20 illustrates how the invention manages all hiring aspects, from job application to applicant qualification. In one instance, the hiring process begins with a prospective applicant accessing a trucking company's home page. An employment application page having a specific URL is provided to each company using the service. Using a browser equipped computer 21, an applicant can complete the job application online (at any physical location), and upon completion, can send the completed application to the URL specified (step 200). Upon receipt, the application recognizes the client (from the URL) and stores the application accordingly in the data store 113. An applicant can obtain and complete a paper application from the company. The paper application is completed by the applicant and forwarded to the company for entry into the system by a member of the employer's administration staff (step 201). The applicant's data is stored in the data store 113. The personnel responsible for applicant screening at the company of interest preliminarily review the application (step 203) using a browser equipped computer 21 to access the home page. A user ID and password for log in is used to provide security. A priority can be given to the application (step 204). The screening process, which is defined by the user, evaluates answers to questions that the applicant has provided and then assigns the applicant to a priority one—the highest priority, or priority two, a lower priority. The priority system allows the user the ability to view the most qualified applications submitted first based on the screening process. The application displays the applicant information (step 205) and allows an administrator to either reject an applicant (step 209) based on not meeting minimum requirements (step 207), or request that a background check is performed (step 211). A previously rejected applicant can be reconsidered.

The system transparently subscribes to and queries various agencies 61, 65, 59, 69, 67 over the Internet using the plurality of gateways for information pertaining to the immediate applicant (step 213). Information such as records from a motor vehicle department, information from a previous employer, information from agencies associated with the industry, and other electronic forms. The queries can be in the form of an email, or directly accessing a data link of interest. For agencies where information cannot be obtained electronically, forms can be printed and forwarded to those agencies for manual action (step 215). The applicant can include other additional information in the form of notes, or digitizing paper documents to be associated with an applicant's file.

The system receives the solicited, and can also receive non-solicited information (step 217) forwarded by agencies 61, 65, 59, 69, 67 in electronic form via the gateways and normalized (in the normalizer 101) if necessary. The information is passed to the compliance engine 105. The compliance engine 105 processes the information, matching received data with data in the data store 113. The compliance engine 1O5 associates received information with an individual's (applicant or employee) file, and adds to or completes information fields for a file. An alert is provided on the company's interface (home page) upon receiving new information or by a preferred mode (IM, Blackberry, email, etc.). The administrator can review the job application again after receipt of the solicited information (step 219) and similarly reject the application based upon the new information (step 221) or continue the hiring process by requesting pre-qualification checklists for the prospective applicant be forwarded to him for completion (step 223). The system prints out an applicable checklist for forwarding, or if delivery is by electronic means, an electronic form is forwarded via email. The pre-qualification checklist lists government requirements such as previous employer alcohol/drug tests, medical examination certificates, pre-employment drug screens, road tests, and other information.

After receipt of the completed checklist (step 225), either electronically or by postal mail, it is added to the applicant's file with the employer alerted. The company administrator reviews the results of the checklist and can reject the applicant (step 229) or indicate that the applicant is ready to qualify (step 231). Qualification specifies whether the applicant can function as a fully complying employee, or if there are restrictions in his duty due to not meeting a specific requirement. A review is performed on whether there is enough information for a final hiring decision (step 235) or whether the applicant should be rejected (step 237). If additional information is necessary (step 239), the applicant file is returned to an earlier requirement stage (step 207) and the process repeated. If the decision is to hire the applicant (step 241), the applicant data is converted to employee data and the new employee's data is submitted to the compliance engine 105 generating any system alerts corresponding to the employee.

The application provides an overseeing function for all employees entered into the system. All data associated with an employee is policed for compliance such as qualification updates based on regulatory requirements, alcohol and drug testing requirements and policies, any relevant accident information to report, general employee information and updates, and other activities. The compliance engine 105 compares employee data with each regulatory requirement and requirements (custom) imposed by the company. This ensures full compliance. For each employee, as their periodic qualification requirements approach, alerts are posted a predetermined number of days prior to expiration. For example, if an employee requires re-qualification to operate a particular commercial motor vehicle, the invention will issue an alert on the company's home page, or by a preferred mode of delivery, a predetermined number of days prior to expiration. This allows ample time for the employee to participate in a re-qualification program and be tested well before expiration.

Referring to FIG. 21, an applicant is screened and qualified during the hiring process (step 301). As discussed above, the hiring process allows a user to import employee data exported from another system (online job application) into the application and also allows for the user to communicate directly with the application and submit employee data through the gateways. All employee data is stored in the data store 113 (step 307). The compliance engine retrieves employee data and examines each record for compliance with all applicable regulatory provisions stored in the data store 113 in dependence upon the employee's compliance cycle. Each employee can have an entirely different compliance schedule based upon when qualification, medical and alcohol and drug tests were given. For each compliance requirement (step 311), the compliance engine 105 identifies when a non-complying condition will occur and calculates a predetermined number of days prior to the event. The period before non-compliance is based on what requirements need to be satisfied, i.e., whether a lengthy re-qualification course is required, or if just a routine drug test.

The compliance engine examines all relevant data in an employee's file for driver qualifications (step 313), alcohol and drug testing (step 315), accident information (step 317) and general training (step 319). Any approaching non-complying events are noted (step 321) and posted for delivery to the employer as an alert (step 323). If a preferred mode of delivery was selected, the alert will be forwarded accordingly (steps 325 and 327). Any alerts that are posted can be reviewed by authorized personnel (step 329) along with any information under a tab.

The driver management system allows those responsible for safety, compliance, risk management, loss prevention, employee training, and recruiting to significantly improve the operational, performance of these functions. The invention allows companies to adhere to strict DOT (federal, state, municipal) requirements, while implementing company specific best practices for dealing with corporate objectives. The benefits include standardization of safety and compliance functions (driver qualification, drug and alcohol programs, accident management) across a company; standardization and management of corporate training programs for all employees, at all locations; standardization of employee hiring processes, practices, and programs, recruiters and hiring managers across an organization; implementation of a consistent corporate-wide safety and compliance program capable of responding to all federal, state, local, or company-specific reporting and tracking requirements; automation of the employee and driver recruiting process, applicant hiring and screening process, and applicant tracking process; real-time notification of “compliance gaps,” compliance issues, and non-compliance trends across all business units and corporate entities; access to a library of forms and reports to ensure standardized reporting and tracking of all safety, compliance, training, and hiring practices across an organization based on job function, location, or area of responsibility; secured access to employee information based on company location, job function, area of responsibility, or operational need; standardization of audit procedures and practices through remote system access of data and images; a single database that houses employee, driver qualification, training, drug and alcohol, and accident information; automation and standardization of background check, MVR, and drug and alcohol programs through electronic interfaces with third party service providers; automation of reoccurring tasks (safety, compliance, training, qualification) defined for an employee, driver, or piece of equipment to track, monitor, report, and manage government or company specific activities; parameter driven features that allow for ad-hoc reporting that is specific to a user, or available across a company; data migration, document imaging, and training (on-site and telephone) services to, streamline the implementation and maximize the on-going use of the service; on-going account management, client service, and end-user support.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method for managing commercial drivers comprising:
receiving data for at least one individual;
comparing said data with operational requirements; and
notifying a destination entity if said data does not comply with said operational requirements.

2. The method according to claim 1 further comprising subscribing to a plurality of entities to obtain additional information relating to said at least one individual.

3. The method according to claim 2 further comprising receiving information from at least one of the plurality of subscribed entities.

4. The method according to claim 3 further comprising determining if said received information corresponds with said data.

5. The method according to claim 4 further comprising associating said received information with said corresponding data.

6. The method according to claim 5 further comprising determining if said received information relates to an operational requirement of a transportation enterprise.

7. The method according to claim 6 further comprising normalizing said received information upon receipt.

8. The method according to claim 7 further comprising accessing presence information for said destination entity notification.

9. The method according to claim 8 wherein said operational requirements include regulatory requirements.

10. A system for managing commercial drivers, the system comprising:
means for receiving data for at least one individual;
means for comparing said individual data with operational requirements; and
means for notifying a destination entity if said individual data does not comply with said operational requirements.

11. The system according to claim 10 further comprising means for subscribing to a plurality of entities to obtain additional information relating to an individual.

12. The system according to claim 11 further comprising means for receiving information from at least one of the plurality of subscribed entities.

13. The system according to claim 12 further comprising means for determining if said received information corresponds with said data.

14. The system according to claim 13 further comprising means for associating said received information with said corresponding data.

15. The system according to claim 14 further comprising means for determining if said received information relates to an operational requirement for a transportation enterprise.

16. The system according to claim 15 further comprising normalizing said received information upon receipt.

17. The system according to claim 16 further comprising means for accessing presence information for notifying a destination entity.

18. The system according to claim 17 wherein said operational requirements include regulatory requirements.

19. A system for managing commercial drivers comprising:
a data store for receiving data for at least one individual, said data including information relating to operational requirements;
a compliance engine coupled to said data store for comparing said data with operational requirements; and
a notification engine coupled to said compliance engine operative to select a destination entity based on said compliance engine comparison.

20. The system according to claim 19 further comprising a plurality of channels enabling two-way communication between a like plurality of predetermined entities.

21. The system according to claim 20 further comprising a normalizer coupled to said plurality of channels to accept and convert received information into a compatible format.

22. The system according to claim 21 further comprising a subscription engine coupled to said compliance engine and said normalizer, said subscription engine subscribes to external systems for individual information and regulatory requirements.

23. The system according to claim 22 further comprising a notification gateway to send notification to said destination entity.

24. A driver management system comprising:
a driver qualification interface through which a user receives alerts regarding whether a driver needs to complete qualification requirements in order to drive certain vehicles and alerts regarding when qualifications must be renewed;
a drug testing interface through which a user communicates with drug testing providers and tracks drug testing requirements and results;
an accident reporting interface through which a user may maintain an accident register and to receive information regarding whether post-accident drug testing or a driver is required and information regarding whether an accident must be reported to a governmental agency;
a training interface through which a user maintains a log of at least one driver's completed and future training;
a hiring interface; and
a file maintenance interface, the driver management system also including a data layer having a plurality of stored procedures and database tables.
